(19) United States
(12) Patent Application Publication
(10) Pub. No.: US 2007/0168271 A1
(43) Pub. Date: Jul. 19, 2007

(54) Method and system for collecting and evaluating insider transaction data

(76) Inventors: Russel Scott Szurek, Princeton, NJ (US); William Charles Martin, Princeton, NJ (US)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 11/333,920

(22) Filed: Jan. 18, 2006

(51) Int. Cl. G06Q 40/00

(52) U.S. Cl. 705/36 R

(57) ABSTRACT

The present invention relates to methods and systems for evaluating insider financial transaction data in which a transaction score is determined for an insider transaction using one or more attributes of public insider financial transaction data. The transaction score can be used for determining a value or ranking for a company, industry or individual. For example, the value can be a positive indication indicating that the transaction score has a positive value relating a buy value or the value can be a negative indication indicating that the transaction score has a negative value relating to a sell value. According to one embodiment, one or more attributes are used for determining the transaction score and the attributes can be weighted differently. Example attributes include type of the insider transaction, size of the insider transaction, position of an insider making the insider transaction and percentage of change of ownership of an insider after the insider transaction. Various displays or reports can be generated for displaying the transaction score and one or more selected fields of information directed to the public insider financial data.

### BACKGROUND OF THE INVENTION

1. Field of the Invention

The present invention relates to a method and system for collecting and evaluating insider transaction data in which insider transactions are collected and each insider transaction is scored. The scored transaction provides value information related to companies, industries and individuals and the resulting information can be manipulated and displayed.

2. Description of Related Art

Conventional systems have been used to gather data on publicly traded companies and public securities trades that take place. U.S. Patent Application No. 2005/0055302 describes a system and method for gathering and manipulation of shareholders data including information on individual shareholders and related custodians of shares for checking company compliance. The system also compares the shareholders/custodian data in order to automatically create a new securities marketing plan or evaluate an existing securities marketing plan.

Systems are also known for collecting public filing information for rating financial reporting practices of public companies. U.S. Patent Application No. 2004/0117283 describes a method and system for evaluating and rating financial reporting practices of public companies. Public filing information for a company such as 8Ks, 10Ks, 10Qs and proxies are separated into predetermined rating categories. The company rating of financial reporting practices can be coupled with peer company ratings.

It has been reported that insider buys are informative and provide valuable information signals. See Academic Whitepaper, How Informative are Analysts Recommendations and Insider Trades (Apr. 12, 2005). It is desirable to provide a method and system for collecting information directed to insider transactions and evaluating the collected information.

### SUMMARY OF THE INVENTION

The present invention relates to methods and systems for evaluating insider financial transaction data in which a transaction score is determined for an insider transaction using one or more attributes of public insider financial transaction data. The transaction score can be used for determining a value or ranking for a company, industry or individual. For example, the value can be a positive indication indicating that the transaction score has a positive value relating a buy value or the value can be a negative indication indicating that the transaction score has a negative value relating to a sell value. It has been found that higher scored buy transactions predict higher returns compared to lower scored transactions.

According to one embodiment, one or more attributes are used for determining the transaction score and the attributes can be weighted differently. Example attributes include type of the insider transaction, size of the insider transaction, position of an insider making the insider transaction and percentage of change of ownership of an insider after the insider transaction. Accordingly, the type of transaction such as sell, exercise and sell and 10B5-1 sell transactions are separately identified and scored In one embodiment, a company scorecard can be generated by including all insider transactions (including transaction scores), for a plurality of companies. Transaction scores associated with a specific company can also be used to create a rank or score for that specific company. In an alternate embodiment, transaction scores associated with a specific industry can be used to create a rank or score that specific industry and sub-industries within the industry. Inflection points can be generated for companies and industries using changes in company and industry scores to indicate if there is a change between positive and negative activity. Various displays or reports can be generated for displaying the transaction score and one or more selected fields of information directed to the public insider financial data.

The invention will be more fully described by reference to the following drawings.

### BRIEF DESCRIPTION OF THE DRAWINGS

FIG. 1 is a flow diagram of a method for collecting and evaluating financial transaction data in accordance with the present invention.

FIG. 2 is a flow diagram of a method for determining a score for insider financial transactions.

FIG. 3 is a flow diagram of a method for determining company scores based on insider transactions related to the company.

FIG. 4 is a flow diagram of a method for determining industry scores based on insider transactions related to the industry.

FIG. 5 is a flow diagram of a method of creating a display or report of best and worst companies.

FIG. 6 illustrates an exemplary display screen or report containing information relating to a company's insider trading activity.

FIG. 7 illustrates an exemplary display or report including information related to an industry's insider trading activity.

FIG. 8 illustrates an exemplary display or report including information related to best and worst stocks.

FIG. 9 illustrates an exemplary display or report including information related to an individual insider trade.

FIG. 10 illustrates an exemplary display or report including information related to a template for selecting parameters to be displayed or reported.

FIG. 11 illustrates an exemplary display or report including information related to daily or weekly updates for companies selected to have alerts.

FIG. 12 is a schematic diagram of a system for collecting and evaluating financial transaction data.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

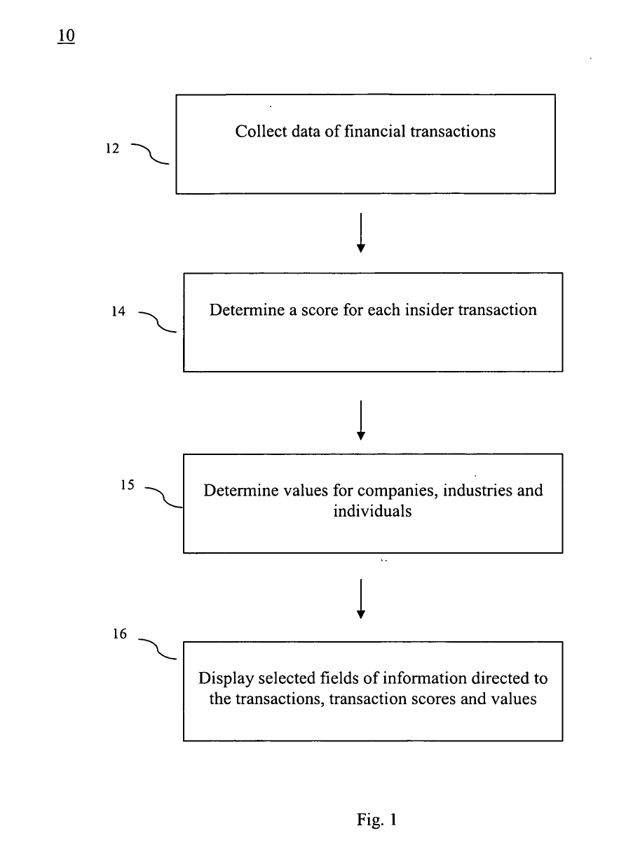

FIG. 1 is a flow diagram of a method for collecting and evaluating financial transaction data 10 in accordance with the teachings of the present invention. For example, the financial transaction data can be related to financial transactions of publicly traded companies. In block 12, data of financial transactions is collected. In one embodiment, the data collected is data from the Securities and Exchange Commission (SEC) reporting filing requirements. For example, the data can be directed to filings for insider trading transactions which individuals or institutions are required to file with the SEC such as data from Form 3, Form 4, Form 5, Form 13E, 13D, 13EA, 13DA, 13H, 8K, 144, proxies and the like.

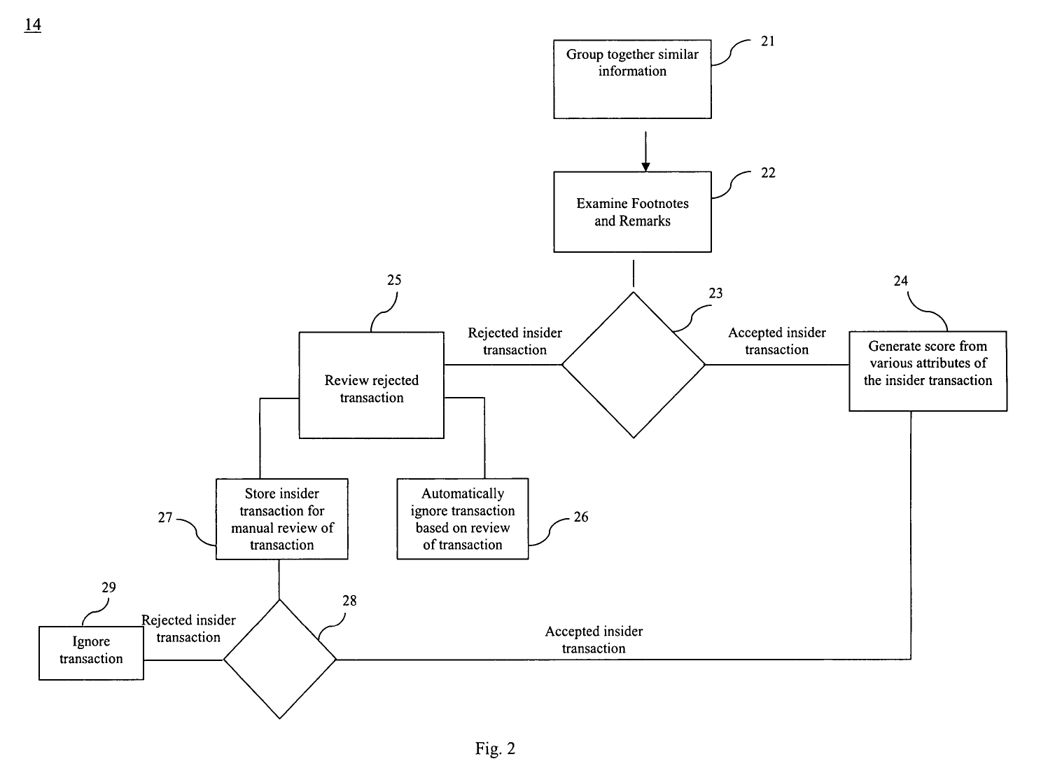

In block 14, a score for each insider financial transaction is determined. An embodiment for determining a score for each insider financial transaction is shown in FIG. 2. In block 21, any similar information of the collected data of financial transactions is grouped together. For example, a SEC filing can have multiple insider transactions and each of the insider transactions can be grouped together. In block 22, footnotes and remarks of the SEC insider filings are reviewed. For example, the footnotes and remarks can be reviewed. From the information in block 21 and block 22, a decision is made in block 23 to accept the insider transaction or reject the insider transaction. The decision in block 23 can be based on whether the insider transaction is an accepted filing type. For example, accepted filing types can be open market buy, open market exercise, open market sell, exercise and sell or a 10B5-1 sell.

If the insider transaction is determined as accepted, a score is generated from one or more attributes of the insider transaction in block 24. For multiple transactions which have been grouped together in block 21, a score is generated for the grouped entity of transactions. For example, the insider transaction can be scored based on the attribute of the type of accepted transaction, as described above. The insider transaction can also be scored based on the attribute of the size of the insider transaction. The size of the insider transaction can be determined from the number of shares or the monetary value of the insider transaction. The insider transaction can also be scored based on the attributes of the position of the insider making the transaction. Example positions of insiders include CEO, CFO, Officers, Directors, and 10% owner, or other types of ownership. The insider transaction can also be scored based on the attribute of whether the transaction was a direct transaction, such as from the shareholder, or an indirect transaction, such as from a shareholder's representative. The insider transaction can also be scored based on an attribute directed to the percentage of change of ownership of the insider after the transaction. The insider transaction can also be scored based on stock percentage change before the insider transaction and stock percentage change since the last transaction of an insider making the insider transaction.

In one embodiment, each of the attributes can be separately weighted and combined to generate a score of the insider transaction. The weights can be applied to generate a score within a predetermined range. For example, the score can be within a range of +4 to −4. Scores having a positive value can indicate buy transactions and scores having a negative value can indicate sell transactions. Scores having a greater positive value can indicate a more notable buy, scores having a greater negative value can indicate a more notable sell. A template or key can be used for evaluating the scores. For example, a notable buy can be determined for a score within a particular range, for example, from about +0.6 to about +1.4, a very notable buy can be determined within a particular range, for example, a score greater than about +1.4 and a notable sell can be determined for a score within a particular range, for example less than about −2.0.

If the insider transaction is determined as rejected in block 23, the rejected transaction is reviewed in block 25. Depending on the reason for rejection, some transactions are automatically removed. Others are put in a queue for a data integrity specialist to review. Insider transactions can be determined to be automatically ignored based on review of attributes of the transaction in block 26. For example, the insider transaction can be ignored based on the transaction type. Example types of insider transactions which can be automatically rejected can include employee stock purchase plan buys, director compensation, option grants and insider transactions with price and value inconsistencies. Alternatively, the reviewed rejected insider transaction can be stored for manual review in block 27. In one embodiment, the rejected insider transaction can be stored for review by a data integrity specialist. For example, the integrity specialist can determine duplicate transactions, mislabeled filings, IPO and secondary transactions and filing errors. In block 28, a determination is made whether to accept or reject the insider transaction. If the insider transaction is determined as accepted in block 28, a score is generated from one or more attributes of the insider transaction in block 24. If the insider transaction is determined as rejected, the individual transaction is ignored in block 29.

Referring to FIG. 1, in block 15, values, ratings and/or inflection points can be determined for company, industry, and individual activity from the insider transaction scores determined in block 14. In block 16, displays or reports of selected fields of information related to the transactions, transaction scores and assorted company ratings are created.

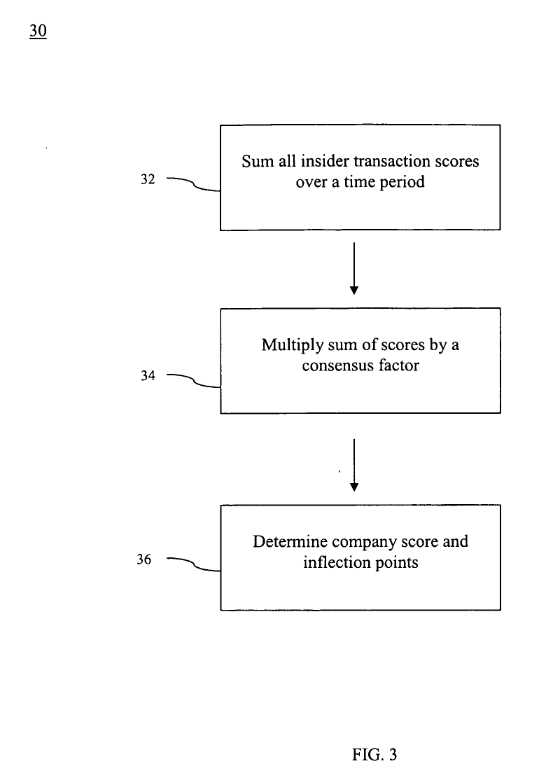

FIG. 3 is a flow diagram of a method for determining company scores based on transaction scores for insider activity at a specific company. The company score can be used to rate a company or determine the level of insider sentiment, based on insider trading. In block 32, a sum is determined of all insider financial transaction scores over a period of time. For example, the sum of insider transaction scores can be determined for transactions of a company over the previous six months. In block 34, the determined sum of insider transaction scores is multiplied by a consensus factor. The consensus factor is related to the number of unique buyers versus unique sellers in the time period, for example, a larger number of individuals buying versus selling would result in a more positive score. In block 36, a company score can be determined. For example, the company score can be represented as a percentile rank. An inflection point can also be determined in block 36. An inflection point represents a positive change or a negative change for the company.

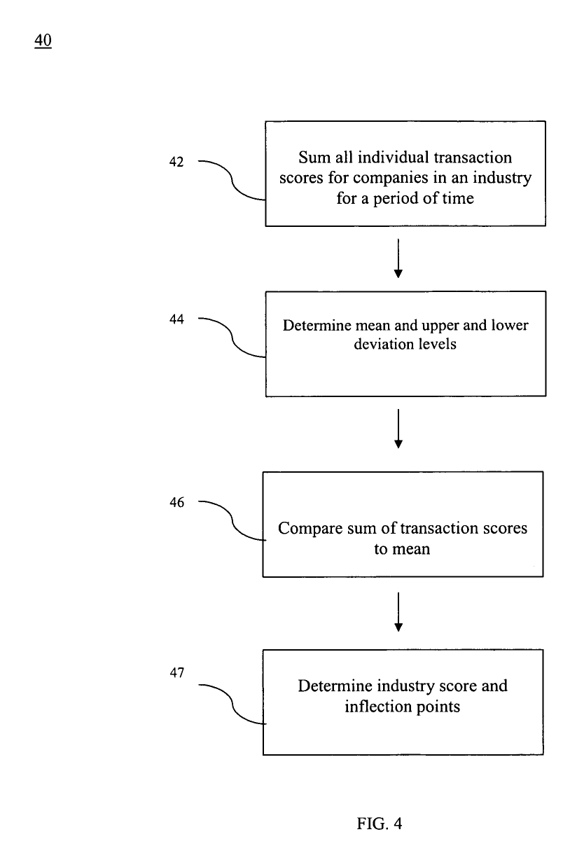

FIG. 4 is a flow diagram of a method for determining industry scores based on transaction scores for insider activity at companies within a specific industry. The industry score can be used to rate an industry based on insider trading. In block 42, a sum is determined for a particular industry over a period of time. For example, the sum of all insider financial transaction scores can be determined for transactions of an industry on a weekly basis. In block 44, the determined sum of transaction scores is used to determine the mean and lower and upper standard deviation levels for an industry grouping. For example, one industry may have a bias towards buying and a higher mean and another industry may have a bias towards selling with a lower mean. In block 46, the sum of transaction scores can be compared to the mean to determine the deviation from the mean. For example, all industries can be compared on a relative basis that takes into account the historical context of the industry. For example, the industry score can be represented as a factor of the industry's determined deviation, such as 0.50× would be 50% of the first deviation value. In block 47, an industry score and inflection points can be determined. For example, the industry score can be represented by percentile rank. An inflection point represents a positive change or a negative change for the industry.

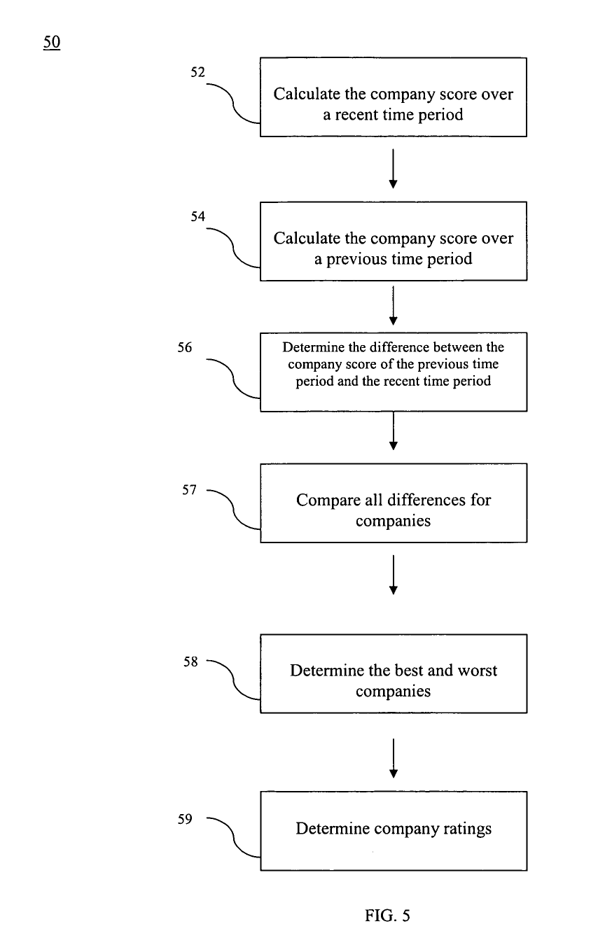

FIG. 5 is a flow diagram of a method of creating a display or report of best and worst companies using the methods described in FIG. 1 and FIG. 3. In block 52, the company score over a recent time period is calculated, for example, for the previous month. In block 54, the company score over a previous time period is calculated, for example, for the five months before the previous month. In block 56, the difference between the company score of the recent time period and the previous time period is determined. Blocks 52-56 are repeated for all companies to be included in the display or the report of the best and worst companies. In block 57, all differences for all companies are compared to determine a rating for each company. In block 58, the best and worst companies are determined by ordering the company ratings with companies having the highest ratings being determined as the best companies and the companies having the lowest ratings being determined as the worst companies. In block 59, company rankings can be determined from the company ratings for ranking each of the determined best and worst companies in order.

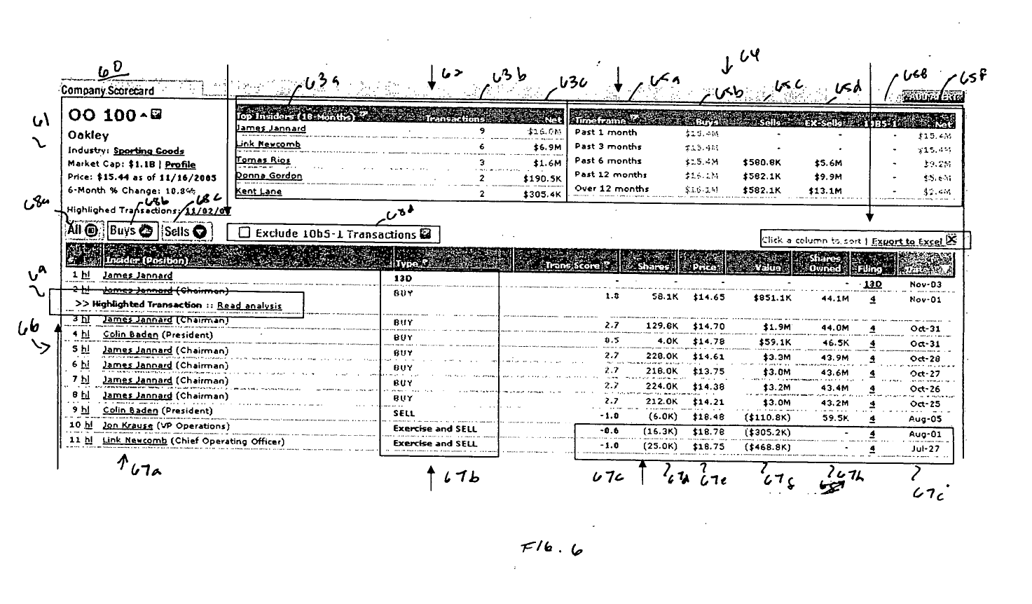

FIG. 6 illustrates an exemplary display screen or report 60 containing information relating to a company's insider trading activity determined from the method described in FIG. 1-FIG. 3 to provide a company scorecard. The display or report provides a company scorecard for expeditious review of insider activity at a company. The selected fields of collected transaction data to be displayed can include one or more of identities of insider traders, identities of positions of the insider traders, number of transactions, net value of the transactions, time frames, types of individual transactions, determined score for individual transactions, shares, price, shares owned, and ranking information.

Portion 61 displays indicia related to the identity of the company, the industry and the price of shares as of a certain date. Portion 62 displays indicia of the top most active insider traders and a net value of their transactions. For example, individual data of five insider traders is displayed in portion 62 including indicia of the name of the top insider traders over a previous time period, such as 18 months, in column 63a, the number of transactions of each insider trader in column 63b, and the net value of each of the insider trade transactions in column 63c. Portion 64 displays indicia relating to insider trading activity based on a timeframe to provide information during the time frame on trading trends. Indicia of a timeframe is displayed in column 65a. For example, the time frame can be the past three months, past six months, past 12 months, and the like. Accordingly, from the displayed timeframes trends can be determined. Data related to values of buys, sells, exercise sell, 10B5-1 and net value is displayed respectively in columns 65b-65f.

Portion 66 displays indicia directed to the insider trading transactions in which each transaction that was accepted in block 28 is displayed and separately labeled. Indicia related to data of an individual making the insider trade is displayed in column 67a. Indicia of data related to the type of transaction is displayed in column 67b. Indicia of the score of the insider transaction is displayed in column 67c. Indicia of data of information of the transaction of the number of shares, price, value, number of shares owned, type of filing and date is displayed in respective columns 67d-67f.

Interface buttons 68a-68d can be used to change the types of transactions displayed. Interface button 68a can be activated to alter the display in portion 66 for displaying indicia of data related to all types of transactions. Interface button 68b can be activated to alter the display in portion 66 for displaying indicia of data related to buy types of transactions. Interface button 68c can be activated to alter the display in portion 66 for displaying indicia of data related to sell types of transactions. Interface button 68e can be activated to sort the information displayed in portion 66 by any column. Interface button 68f can be activated to export display results to a file, such as an Excel file. Interface button 68d can be activated to alter the display in portion 66 for excluding 10B5-1 sells from the display. A transaction can be highlighted with display portion 69 and analysis for the transaction can be displayed.

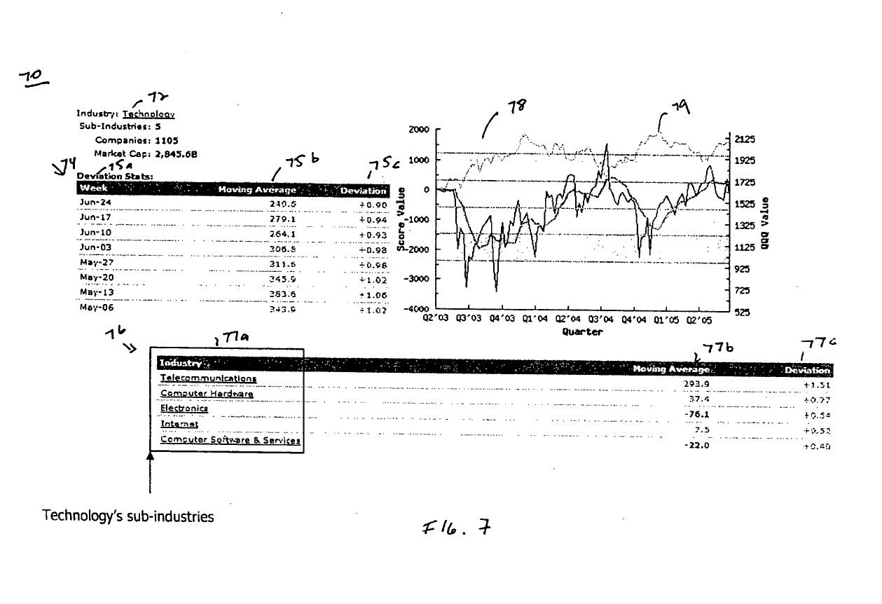

FIG. 7 illustrates an exemplary display or report 70 created in block 16 including information related to an industry's insider trading activity as determined from the method performed in FIG. 1, FIG. 2 and FIG. 4. Portion 72 displays indicia related to the identity of the industry, the number of sub-industries, the number of companies and the market cap. Portion 74 displays indicia of the determined industry transaction scores and deviation from the mean. Indicia of a time frame is displayed in column 75a. Indicia of an average of the industry transaction scores is displayed in column 75b. Indicia of the deviation of the industry from the mean is displayed in column 75c. Portion 76 displays indicia of results from a sub-industry. Column 77b displays indicia of an average of the industry transaction scores. Column 77c displays indicia of the deviation of the industry from the mean. A graphical representative of the score values versus a time frame is displayed in portion 78. The QQQ value is related to line 79. Line 79 displays the most appropriate index (for example, QQQ) for each industry or index. Accordingly, the display or report portrays the insider sentiment and how it corresponds to price activity.

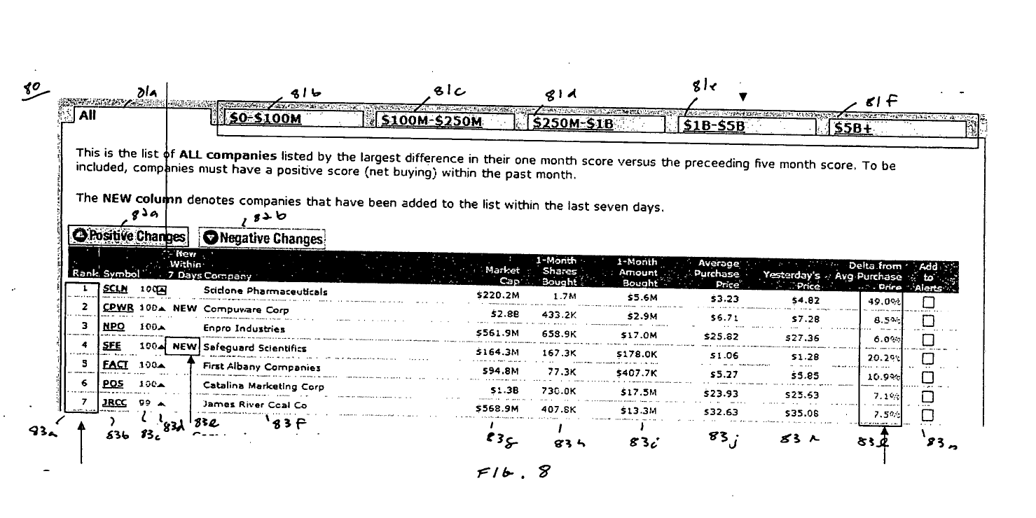

FIG. 8 illustrates an exemplary display or report 80 including information related to best and worst stocks as determined from the method performed in FIG. 1, FIG. 2 and FIG. 5 for displaying companies experiencing the most notable changes in buying and selling versus past buying and selling trends. Interface tabs 81a-81f can be used to change the types of transactions displayed on report 80 based on market cap grouping. Buttons 82a, 82b can be used to change the types of transactions displayed of companies having a positive change or companies having a negative change. A company ranking, such as determined from block 49 described above, is displayed in column 83a. Indicia of a symbol of the company is displayed in column 83b. Indicia of a company score determined from block 44 is displayed in column 83c. An inflection point indicating a positive or negative change of the company determined from block 47 is displayed in column 83d. The inflection point can be displayed with indicia such as an upward triangle having a predetermined color, for example green, to indicate a positive inflection point and with indicia such as a downward triangle having a predetermined color, for example red, to indicate a negative inflection. Column 83e can be used to determine companies which have recently been added to report 80. For example, column 83e can display indicia of companies that have been added to the list within the past seven days as new companies. Column 83f displays indicia of the company name. Columns 83g-83l displays indicia of data directed to the company shares and financial information such as market cap, in column 83g, one-month shares bought in column 83h, one-month amount bought in column 83i, average purchase price in column 83j, yesterday's price in column 83k, and difference of insider trading or price form an average purchase price in column 83l. Column 83n can activate adding an insider transaction to an alert which is forwarded to a user as described below.

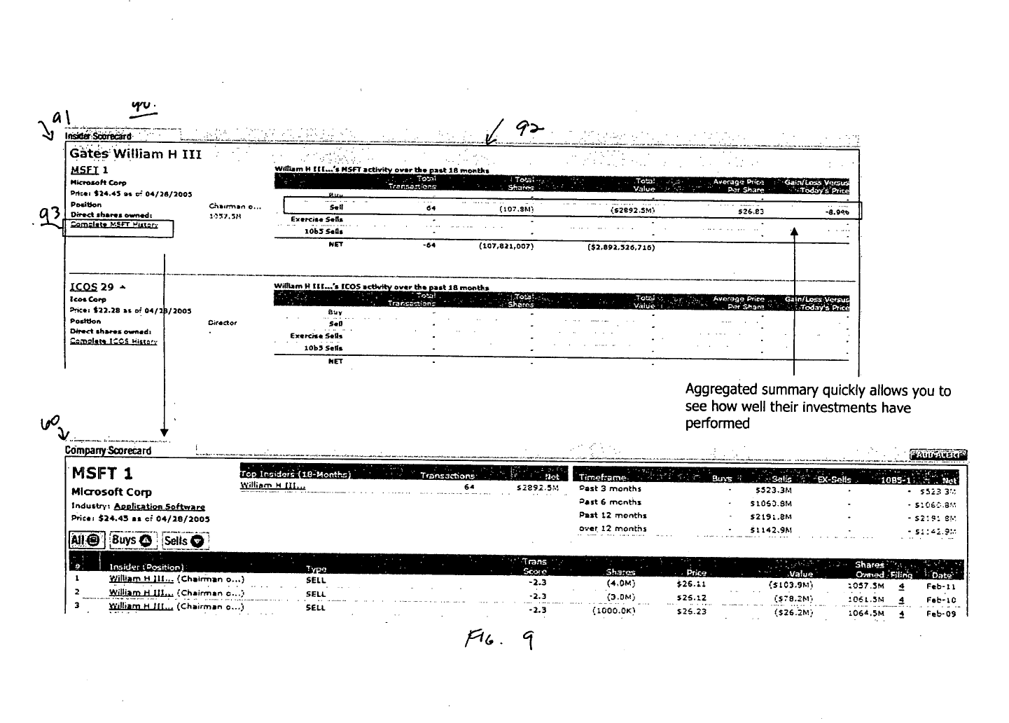

FIG. 9 illustrates an exemplary display or report 90 including information related to an individual insiders as determined from the method of FIG. 1 and FIG. 2. Portion 91 displays indicia related to the identity of the individual and companies at which insider trades were made. Portion 92 displays a summary of the individual activity over a time period, such as the previous eighteen months. Interface button 93 provides an interface to a link to a history of the individual's transactions for a related company and to display report 60 of a company scorecard as described above. The aggregated summary allows users to expeditiously determine how well the stock has performed since the insider's average purchase price.

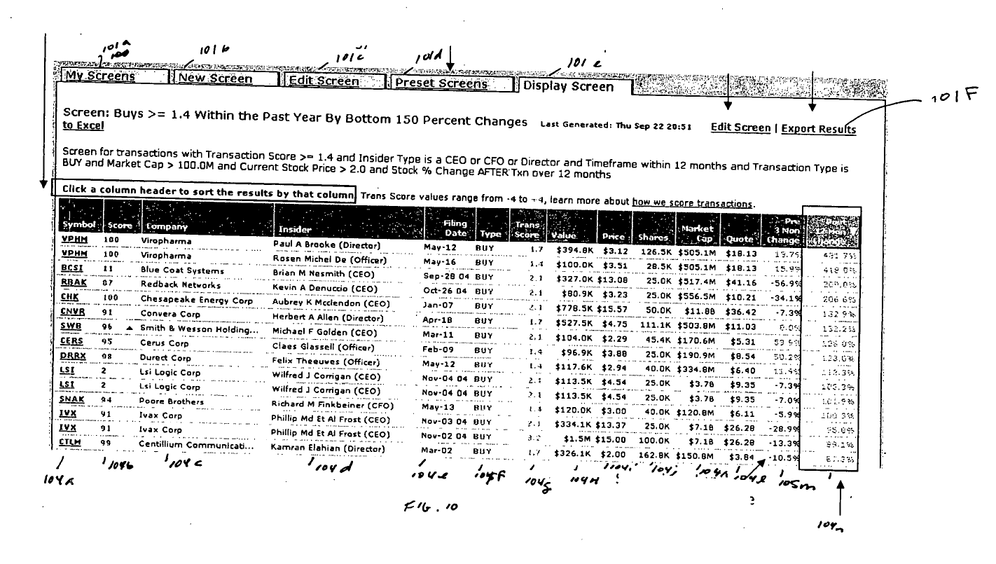

FIG. 10 illustrates an exemplary display or report 100 created in block 16 including information related to a template for selecting parameters to be displayed or reported. Interface button 101a is activated to display screens previously created referred to as “my screens”. Interface button 101b is activated to a display a new screen. Interface button 101c is activated to edit a previously created screen. Interface button 101d is activated to display preset screen templates which can be individually customized. Interface button 101e is highlighted when a screen name is selected to view the results of the selected screen to display previously created screens. Portion 102 displays one or more selected fields of information and determined score values which can be selected using edit selection button 101c or preset screen button 101d. Export results button 101f can be activated to export display results to a file, such as an Excel file. For example, column 104a displays indicia of a company symbol. Column 104b displays indicia of a company score. Column 104c displays indicia of a company name. Column 104d displays indicia of an insider trader name. Column 104e displays indicia of a filing date of the insider transaction. Column 104f displays indicia of the type of individual transaction. Column 104g displays indicia of an individual transaction score. Column 104h displays indicia of a value of the transaction. Column 104i displays indicia of a price of each share in the transaction. Column 104j displays indicia of the number of shares in the transaction. Column 104k displays indicia of a value of the market cap. Column 1041 displays a quote. Quote is a recent stock quote for the company that the insider transaction is related to. Column 104m displays a change from previous months, such as a percent change for the past three months before the transaction. Column 104n displays the percent change from the day after the transaction takes place to a future date, such as the percent change for three months after the transaction. The header of each of columns 104a-104n can be activated, such as by clicking with a mouse, to sort the results of the column associated with the header.

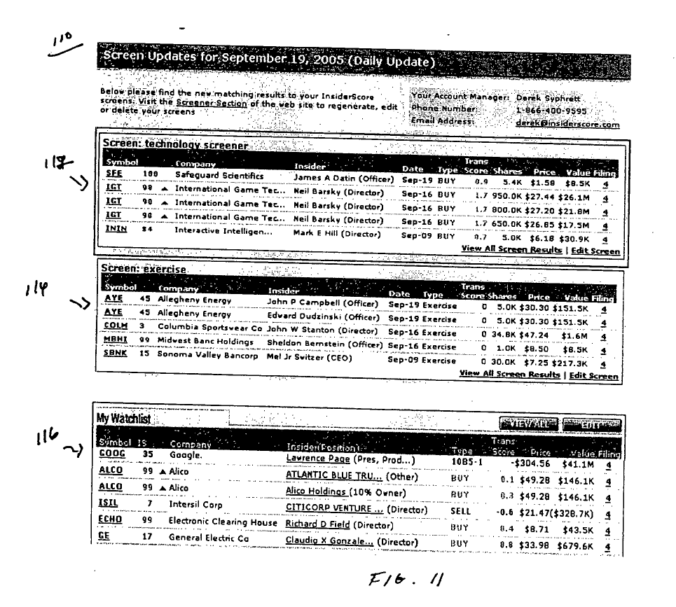

FIG. 11 illustrates an exemplary display or report 110 created in block 16 including information related to user selected parameters and corresponding electronic mail sendings. Based on user selected parameters, matching insider transactions are sent in a consolidated format, for example, display 100 depicts examples of daily or weekly settings for screens created in FIG. 10, using interface button 101b. For example, display 112 displays one or more selected fields of collected transaction data in the technology industry having insider buying of a particular magnitude. Display 114 displays one or more selected fields of collected transaction data for a particular accepted transaction type, such as an exercise. Display 116 displays a consolidated listing or matching of insider transactions related to the user's watchlist, companies for which an alert was activated using button 104n. Report 110 can be pushed to a user via an electronic mail.

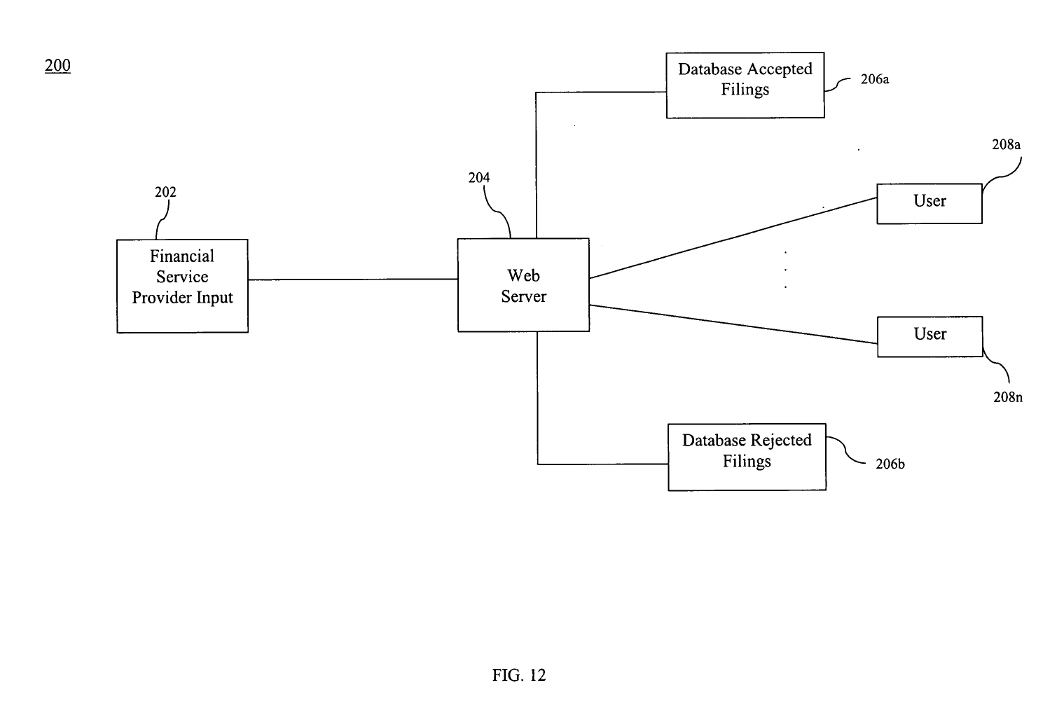

Various aspects of the present invention can utilize a rules-based computerized system 200 as shown in FIG. 12. The rules-based computerized system is provided with financial information 202 derived from U.S. Securities and Exchange Commission data. The financial information used by the invention can be obtained by various financial information providers such as, for example, MULTEX, COMPUSTAT, and MEDIA GENERAL, and stored as structured information in a database. Alternatively, the financial reporting information can be directly obtained from the financial reports or by using the SEC's EDGAR database, which provides access to such reports via the Internet. Rules and logic as described above for FIG. 1-FIG. 5 are applied in a processor. An embodiment of the present invention utilizes the Application Service Provider (ASP) or Web server 204 model as a processor. As is understood by those of skill in the art, an ASP is an entity that offers individuals and enterprises access to the Internet (or other communications network) to applications and related services that would otherwise have to be located in local computers and/or devices. Exemplary data processing systems which may be utilized in accordance with embodiments of the present invention include, but are not limited to Dell™, Sun Microsystems, Apple®, IBM® or IBM®-compatible personal computers and workstations. However, it is to be understood that various computing devices and processors may be utilized to carry out embodiments of the present invention without being limited to those enumerated herein. An exemplary operating system may include LINX®, UNIX, Windows 98®, Windows 2000®, or Windows NT®. The Web server for use in the invention is configured to handle communications with client devices and other devices that are in communication with the communications network. Web servers are well understood by those of skill in the art. Data directed to accepted and rejected filings can be stored in respective databases 206a or 206b. Users 208a-208n can access web server 204 for generating and displaying displays or reports. In one embodiment, displays or reports can be updated at web server 204 and pushed to individual users 208a-208n as alerts, such as by electronic mail.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A method for evaluating insider financial transaction data comprising the steps of:
a) obtaining public insider financial transaction data;
b) determining a transaction score for an insider transaction using one or more attributes of said public insider financial transaction data; and
c) determining a value or ranking from said transaction score for one or more of a company, an industry or an individual.

2. The method of claim 1 wherein the public filing information includes information required by the Securities and Exchange Commission to be publicly filed for an insider transaction.

3. The method of claim 1 wherein said insider transaction score is determined by grouping insider transactions of a similar nature from said obtained public insider financial transaction data.

4. The method of claim 2 wherein said similar information is information from a single filing with the Securities and Exchange Commission.

5. The method of claim 1 wherein a transaction score is determined for accepted filing types of insider transactions.

6. The method of claim 5 wherein the accepted filing types of insider transactions are selected from an open market buy, open market exercise, open market sell, exercise and sell or 10B5-1 sell.

7. The method of claim 1 wherein a plurality of said attributes are used for determining said transaction score and at least some of the attributes are weighted differently.

8. The method of claim 7 wherein said attributes are selected from the group consisting of type of the insider transaction, size of the insider transaction, position of an insider making the insider transaction, percentage of change of ownership of an insider after the insider transaction, stock percentage change before the insider transaction and stock percentage change since a last transaction of an insider making the insider transaction.

9. The method of claim 8 wherein the type of accepted transaction is determined as a direct transaction or an indirect transaction and said transaction score is dependent on whether said accepted transaction is determined as said direct transaction or said indirect transaction.

10. The method of claim 8 wherein the size of the insider transaction is determined from a number of shares or a monetary value of the insider transaction.

11. The method of claim 1 wherein said transaction score with a positive value determines said value of a buy value and said transaction score with a negative value determines said value of a sell value.

12. The method of claim 11 wherein said transaction score having a greater positive value indicates a more notable buy and said transaction score having a greater negative value indicates a more notable sell.

13. The method of claim 1 wherein said step of obtaining public insider financial transaction data further comprises the step of:
reviewing footnotes or remarks of said public insider financial transaction data.

14. The method of claim 1 wherein said public insider financial data is obtained via a communications connection.

15. The method of claim 1 wherein in step c), said ranking is determined from said score for one or more said companies by the steps of:
d) determining said transaction score for a plurality of companies;
e) summing said transaction scores for said plurality of companies;
f) multiplying said sum by a consensus factor;
g) applying a limiting factor to said sum to determine a company score;
h) repeating steps d) through g) for determining a company score for each of said companies; and
ranking said companies based on said determined company scores.

16. The method of claim 15 further comprising the step of:
determining if there is an inflection point for each of said company scores.

17. The method of claim 16 further comprising the step of:
generating a display or report of one or more fields of information from said public insider financial transaction data, said determined transaction score and said inflection point, wherein said inflection point is displayed as a first indicia indicating a positive inflection point and as a second indicia indicating a negative inflection point.

18. The method of claim 1 wherein in step c), a ranking is determined from said score for one or more said industries by the steps of:
d) determining said transaction score for a plurality of industries;
e) summing said transaction scores for said plurality of industries;
f) determining a mean from said summed transaction scores;
g) determining a deviation from said mean; and
ranking said industries based on said determined industry scores and deviation.

19. The method of claim 17 further comprising the step of:
determining if there is an inflection point for said industry score.

20. The method of claim 19 further comprising the step of:
generating a display or report of one or more fields of information from said public insider financial transaction data, said determined transaction score and said inflection point, wherein said inflection point is displayed as a first indicia indicating a positive inflection point and as a second indicia indicating a negative inflection point.

21. The method of claim 1 further comprising the step of:
generating a display or report of one or more selected fields of information from said public insider financial transaction data and said determined transaction score.

22. The method of claim 21 wherein said step of generating a display or report generates a display or report comprising information relating to insider trading activity of one or more companies.

23. The method of claim 22 wherein said display or report includes indicia of a predetermined number of insider transactions and a net value of said insider trader transactions.

24. The method of claim 22 wherein said display or report includes indicia related to insider trading activity based on a time frame.

25. The method of claim 22 further comprising the step of interacting within timeframe buttons to alter said display or report to display indicia of data related to all types of transactions, indicia of data related to buy types of transactions, or indicia of data related to sell types of transactions.

26. The method of claim 21 wherein said step of generating a display or report generates a display or report comprising information relating to insider trading activity of one or more industries.

27. The method of claim 21 wherein said display or report includes information relating to insider trading activity of an individual insider trader.

28. The method of claim 21 wherein said step of generating a display or report comprises the step of interacting with an interface to individually customize said display or report.

29. The method of claim 1 further comprising the steps of:
calculating the company score over a recent time period;
calculating the company score over a previous time period;
determining the difference between the company score of the previous time period and the recent time period;
comparing all differences for companies; and
determining the best and worst companies.

30. The method of claim 29 further comprising the step of generating a display or report of one or more selected fields of information from said public insider financial transaction data and said determined transaction score for said determined best and worst companies.

31. A system for evaluating insider financial transaction data comprising:
means for obtaining public insider financial transaction data;
means for determining a transaction score for an insider transaction using one or more attributes of said public insider financial transaction data; and
means for determining a value or ranking from said transaction score for one or more of a company, an industry or an individual.

32. The system of claim 31 wherein the public filing information includes information required by the Securities and Exchange Commission to be publicly filed for an insider transaction.

33. The system of claim 31 wherein said insider transaction score is determined by grouping insider transactions of a similar nature from said obtained public insider financial transaction data.

34. The system of claim 32 wherein said similar information is information from a single filing with the Securities and Exchange Commission.

35. The system of claim 31 wherein a transaction score is determined for accepted filing types of insider transactions.

36. The system of claim 33 wherein the accepted filing types of insider transactions are selected from an open market buy, open market exercise, open market sell, exercise and sell or 10B5-1 sell.

37. The system of claim 31 wherein a plurality of said attributes are used for determining said transaction score and at least some of the attributes are weighted differently.

38. The system of claim 37 wherein said attributes are selected from the group consisting of type of the insider transaction, size of the insider transaction, position of an insider making the insider transaction, percentage of change of ownership of an insider after the insider transaction, stock percentage change before the insider transaction and stock percentage change since a last transaction of an insider making the insider transaction.

39. The system of claim 38 wherein the type of accepted transaction is determined as a direct transaction or an indirect transaction.

40. The system of claim 38 wherein the size of the insider transaction is determined from a number of shares or a monetary value of the insider transaction.

41. The system of claim 31 wherein said transaction score with a positive value determines said value of a buy value and said transaction score with a negative value determines said value of a sell value.

42. The system of claim 41 wherein said transaction score having a greater positive value indicates a more notable buy and said transaction score having a greater negative value indicates a more notable sell.

43. The system of claim 31 wherein said means for obtaining public insider financial transaction data further comprises:
means for reviewing footnotes or remarks of said public insider financial transaction data.

44. The system of claim 31 wherein said public insider financial data is obtained via a communications connection.

45. The system of claim 31 wherein in said means for determining a ranking, said ranking is determined from said score for one or more said companies by:
means for determining said transaction score for a plurality of companies;
means for summing said transaction scores for said plurality of companies;
means for multiplying said sum by a consensus factor;
means for applying a limiting factor to said sum to determine a company score;
means for determining a company score for each of said companies; and
means for ranking said companies based on said determined company scores.

46. The system of claim 45 further comprising:
means for determining if there is an inflection point for said company score.

47. The system of claim 31 wherein in said means for determining a ranking, said ranking is determined from said score for one or more said industries by:
means for determining said transaction score for a plurality of industries;
means for summing said transaction scores for said plurality of industries;
means for determining a mean from said summed transaction scores;
means for determining a deviation from said mean; and
means for ranking said industries based on said determined industry scores and deviation.

48. The system of claim 47 further comprising:
means for determining if there is an inflection point for said industry score.

49. The system of claim 31 further comprising:
means for generating a display or report of one or more selected fields of information from said public insider financial transaction data and said determined transaction score.

50. The system of claim 49 wherein said means for generating a display or report generates a display or report comprising information relating to insider trading activity of one or more companies.

51. The system of claim 50 wherein said display or report includes indicia of a predetermined number of insider transactions and a net value of said insider trader transactions.

52. The system of claim 50 wherein said display or report includes indicia related to insider trading activity based on a time frame.

53. The system of claim 50 further comprising means for interacting within timeframe buttons to alter said display or report to display indicia of data related to all types of transactions, indicia of data related to buy types of transactions, or indicia of data related to sell types of transactions.

54. The system of claim 49 wherein said means for generating a display or report generates a display or report comprising information relating to insider trading activity of one or more industries.

55. The system of claim 49 wherein said display or report includes information relating to insider trading activity of an individual insider trader.

56. The system of claim 31 further comprising:
means for calculating the company score over a recent time period;
means for calculating the company score over a previous time period;
means for determining the difference between the company score of the previous time period and the recent time period;
means for comparing all differences for companies; and
means for determining the best and worst companies.

57. The system of claim 56 further comprising means for generating a display or report of one or more selected fields of information from said public insider financial transaction data and said determined transaction score for said determined best and worst companies.

58. The system of claim 49 wherein said means for generating a display or report comprises means for interacting with an interface to individually customize said display or report.

59. The system of claim 46 further comprising means for generating a display or report of one or more selected fields and said display or report comprises a display or report of one or more fields of information from said public insider financial transaction data and said determined transaction score for said determined best and worst companies and said inflection point, wherein said inflection point is displayed as a first indicia indicating a positive inflection point and as a second indicia indicating a negative inflection point.

60. The system of claim 48 further comprising means for generating a display or report of one or more selected fields and said display or report comprises a display or report of one or more fields of information from said public insider financial transaction data and said determined transaction score for said determined best and worst companies and said inflection point, wherein said inflection point is displayed as a first indicia indicating a positive inflection point and as a second indicia indicating a negative inflection point.
